(19) United States
(12) Patent Application Publication
(10) Pub. No.: US 2017/0256951 A1
(43) Pub. Date: Sep. 7, 2017

(54) Distributed System and Methods for Coordination, Control, and Virtualization of Electric Generators, Storage and Loads.

(71) Applicants: Daniel Crespo-Dubie, Sausalito, CA (US); Joachim Janssen, Berrocales del Jarama (ES)

(72) Inventors: Daniel Crespo-Dubie, Sausalito, CA (US); Joachim Janssen, Berrocales del Jarama (ES)

(21) Appl. No.: 15/451,220

(22) Filed: Mar. 6, 2017

Related U.S. Application Data
(60) Provisional application No. 62/304,151, filed on Mar. 5, 2016.
(60) Provisional application No. 62/304,152, filed on Mar. 5, 2016.
(60) Provisional application No. 62/304,153, filed on Mar. 5, 2016.

(51) Int. Cl. H02J 3/38; G05B 15/02

(52) U.S. Cl. CPC H02J 3/383; G05B 15/02; H02J 3/386; H02J 3/387

(57) ABSTRACT

Distributed System and Methods for Coordination, Control, and Virtualization of Electric Generators, Storage and Loads is disclosed. The system implements a highly distributed architecture and autonomous methods that represent a layer of coordination, control, reporting and interaction closely attached to the loads, distributed generators, and energy storage systems to achieve a desired net balance of energy consumption to the available offer for a given area of control. Furthermore the disclosed system pursue a desired state of phase (reactive or capacitive) and frequency shift in order to contribute to the overall efficiency and reliability of the electric distribution grid.

This application claims the benefit of U.S. Provisional Applications Ser. Nos. 62/304,151, 62/304,152 and 62/304,153 filed Mar. 5, 2016, the entire disclosures of which are incorporated by reference.

### FIELD OF INVENTION

The field of invention relates to the distributed architecture and methods to control, coordinate and virtualize distributed generators, storage and loads connected to the electrical grid.

### BACKGROUND OF INVENTION

The advent of distributed generation of electricity is impacting the distribution grid in a way that the current grid architecture is not able to handle. The distribution grid was architected as a hierarchical hub and spoke network where a central controlling entity coordinates the flow of energy from a small number of large energy sources down the grid to supply multitude of customers at the end branches of the network (loads). Distributed generation and storage, particularly residential and small commercial, transforms traditional electricity consumers into variable suppliers that the central controlling entity has not visibility of or control over, resulting in considerable inefficiencies and energy losses. The problem gets exacerbated when the number of distributed elements grow to represent at least a few percentage points of the overall energy supply.

Having already reached that level the current distribution grid architecture is under stress and there are clear indications that it is no longer viable. A new grid architecture (topology and control) could be deployed to accommodate the changes taken place at the customer sites. This approach will be a very long term and costly endeavor that will most likely fully negate all the economic and environmental benefits that were pursued while developing distributed generation.

### SUMMARY OF THE INVENTION

In view of the foregoing, there is need for a solution that allows to extend the useful life of the electricity distribution grid while preserving the benefits pursued while implementing distributed generation and storage. Our invention addresses this problem by introducing a highly distributed architecture and autonomous methods that represent a layer of coordination, control, reporting and interaction 101 that is closely attached to the loads 105 106 108, distributed generators 106 107 and energy storage 108 systems that provides the utility visibility and some level of control over the end points attached to the distribution grid. Such system 600 will prevent the current grid architecture obsolescence (or at least greatly delay it), can be timely installed, easily scaled up and down, as well as updated and extended to adapt to new paradigms that might be uncovered as the distributed generation offering continues to expand.

### BRIEF DESCRIPTION OF THE DRAWINGS

For a better understanding of the invention and its embodiments, reference should be made to the following detailed description taken in conjunction with the accompanying drawings, in which:

FIG. 1 represents the overall system topology;

FIG. 2 depicts the relationship between the invention components and all the system participants;

FIG. 3 shows the system participants relationships in a tabular depiction;

FIG. 4 high level agent hardware block diagram;

FIG. 5 high level agent software block diagram;

FIG. 6 overall architecture and methods block diagram;

FIG. 7 agent self-configuration and recovery process flowchart;

FIG. 8 area agent selection process flowchart;

FIG. 9 element agent coordination and control process flowchart; multithreaded process;

FIG. 10 area agent coordination and control process flowchart; multithreaded process;

FIG. 11 area virtualization process flowchart; multithreaded process;

FIG. 12 participation framework process flowchart; multithreaded process;

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives and modifications; it is limited only by the claims.

Numerous specific details are set forth in the following description in order to provide a thorough understanding of the invention. However, the invention may be practiced according to the claims without some or all of these specific details.

### System Components and Participants Description

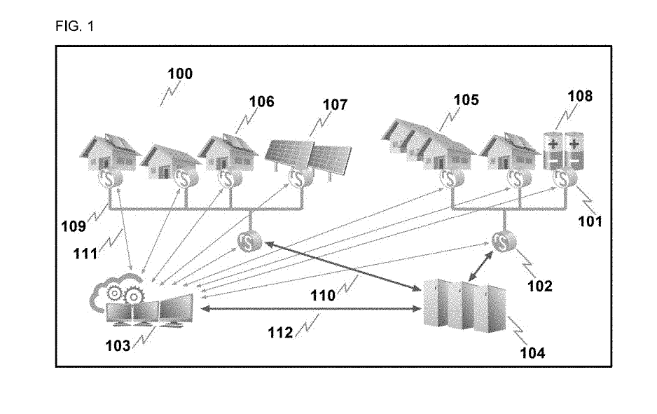

In order to describe the topology of the system and its participants, we will refer to FIG. 1.

The system 600 is mainly intended to coordinate and control loads 105 106 108, distributed generators 106 107 and energy storage 108 elements to achieve a desired net balance of energy consumption to the available offer for a given area of control. Furthermore the coordination elements 101 102 will pursue a desired state of phase (reactive or capacitive) and frequency shift in order to contribute to the overall efficiency and reliability of the distribution grid.

### System Participants

Energy consumer end points 105 106 108: These are discrete loads attached to the distribution grid. They could be all the elements behind a utility meter (e.g. a house, a store, a light pole, etc.) or individual loads installed in a given structure supplied through a utility meter. Each end point has a one to one relationship (connection) to the controlling element 101 (autonomous agent).

Energy generation end points 106 107 108: These are any source of electrical energy (solar panels, wind mills, batteries, etc.) that are directly attached to the distribution grid through a utility meter. Each one of these endpoints has a one to one relationship (connection) to the controlling element 101 (autonomous agent). Depending on the class and physical disposition of endpoints, a single physical agent (node) might connect to several endpoints.

Coordination & Control Entities 101 102 (Autonomous Agents): Hardware and software entities (computing and communication equipment) that implement methods and algorithm intended to autonomously analyze energy dispatches (power, phase shift, frequency adjustment) for a given area, map it to the individual loads, generators and storage elements, report the level of obtainment expected, dispatch the individual elements, measure over the time window allocated and report back on actual obtainment. The Autonomous Agents (hardware, software and methods) constitute the core of the invention. They are further functionally and hierarchically self-organized in Area Control Agents 102 and Element Control Agents 101. Element Control Agents 101 connect to all the agents participating of their area of control.

Operations & Management Entity 103 (Operations Center): This entity takes cares of all the back office operations such as order processing, installation dispatches, system documentation, key performance indicators reporting, billing, etc. In addition it provides supervisory functions over the autonomous agents 101 102 such as configuration and provisioning, overall monitoring, fault isolation and remediation, software upgrades, etc.

Utility/Forecasting Entity/Independent Operators/Competitive Retailers 104: The utility serving the area, a forecasting entity, and/or other electricity retail market participants produces energy dispatches for each area and for a given time window. The energy dispatch will be characterized at least for all or some of net energy amount expected to be consumed in the area, start and end time of the dispatch, desired phase and frequency shifts, frequency of obtainment reports.

### System Participants Relationships

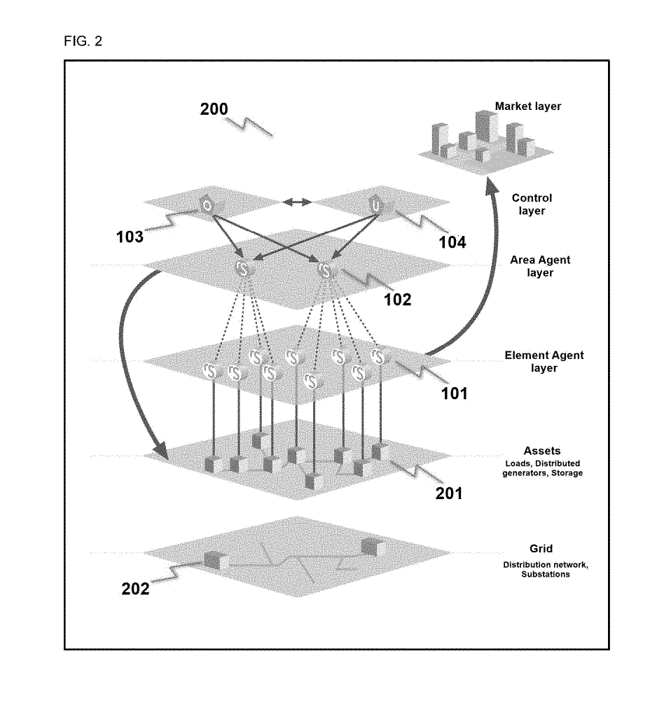

The relationships between the system's participants will vary greatly from directly connected real time one-to-one, to a loosely coupled one-to-many (see FIG. 2). Such relationships are provided in a tabular format for further clarity (see FIG. 3).

### Utility/Forecasting/Retailers

This entity 104 has a long term business relationship with the endpoint generators and loads 201. Their interaction is off-line and periodic. From the system 600 perspective they interact only at installation or service start, and at service termination.

It 104 interacts quasi-real time (forecasting and reporting windows) with area agents 102. It sends periodic forecasts and dispatch adjustments (differential forecasts), while receiving periodic obtainment reports.

The direct connection with the Operations Center 103 is used for periodic back office activities (inventory, billing, etc.) and when needing service updates (additions, removals, troubleshooting and repairs, etc.).

### Operations Center 103

Interacts as needed with all agents 101 102 for provisioning, health check, troubleshooting, software updates, etc.

Interacts with agents 101 102 and utility 104 to set and update security credentials.

Sends utility 104 performance reports, service billing, etc.

### Area Agent 102

Holds a relationship with the utility/forecasting 104 entity in order to receive forecast and dispatches, and send periodic reports (metrics, obtainment, etc.).

Is attached to an endpoint 201 an in such a relationship it behaves as an endpoint agent 101.

Interacts real time with all endpoint agents 101 in the area of control to understand real time availability, break the dispatch into individual components, provide fractional dispatch to each endpoint agent 101, collect measures from endpoint agents 101, etc.

### Endpoint Agents 101

Interacts with its controlled endpoint(s) 201 to execute on a given dispatch and collect measurements.

Interacts with all agents 101 in the area during the area agent 102 selection process.

Exchange information with all peers 101 in their corresponding area.

### System Communication Mechanisms and Flows

The system 600 is designed with flexibility in mind and accommodates diverse communication mechanisms adequate to carry at least the core functions of each entity.

### Utility/Forecasting Entity 104

WAN circuit 112 connect to the Operations Center; cloud access 111 (dedicated WAN circuit or VPN) to connect to the Area Agents.

### Operations Center 103

WAN circuits 112 connecting to utilities 104.

WAN circuits 111 to private cloud.

3G/4G and/or cloud connections 111 109 to Area and Endpoint Agents.

### Autonomous Agents 101 102

3G/4G connections to reach private cloud 109, utility entity 110 and operations center 111.

Wireless and/or wired local area and point to point connections such us WiFi, Bluetooth, ZigBee, Ethernet, X10, RS-232, RS-485, etc. to connect to the associated endpoint(s) 201.

Support for several serial industrial and building control protocols such us ModBus, IEC 60870-5-103/4, M-Bus, etc. to connect to the associated endpoint(s) 201.

### System Security 604

Security is critical in any modern system but more so in a system 600 that has the control capabilities required to coordinate distributed energy generation and loads attached to the distribution grid 202. The system 600 is designed to use an adaptive security paradigm that applies the appropriate level of security depending on the impact of the activity in progress. For example the highest level of security will be applied to dispatches, software upgrades, configuration changes and similarly critical activities. A lower level of security will be used for reporting activities. Such adaptive approach addresses the need to preserve resources (CPU, memory, processing cycles) at the autonomous agent level.

All elements participating of the system 600 use assertive authentication and authorization levels. All transactions are encrypted. Furthermore the system will use a distributed ledger mechanism and associated block chain to secure the integrity of the transactions received and executed by the system 600.

### Autonomous Agents 101 102

Autonomous Agents 101 102 are at the core of the system 100 600 and a critical component of the overall system 600 design. They are comprised of factory level tailored hardware, preinstalled OS and bootstrap (self-configuration and recovery process 700) methods. Once physically installed in the field and powered up, the agent using the self-configuration and recovery process 700 autonomously acquires its configuration, core software upgrades, and agent personality packages (e.g. coordination and control functionality).

### Hardware Description

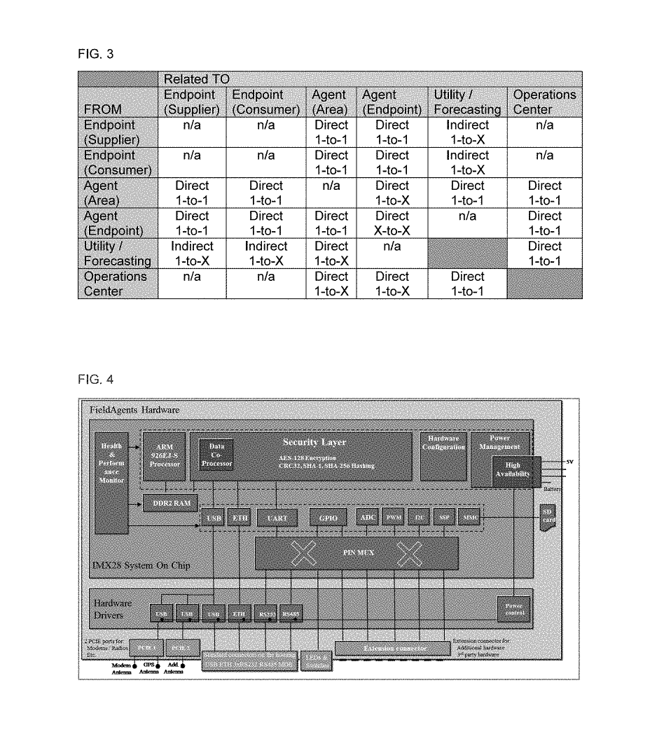

The hardware platform for the Autonomous Agents 101 102 is an ARM based single board computer (see FIG. 4) designed for a high level of integration and flexible connectivity options to meet the variety of situations presented in the energy distribution grid.

### Base Software Description

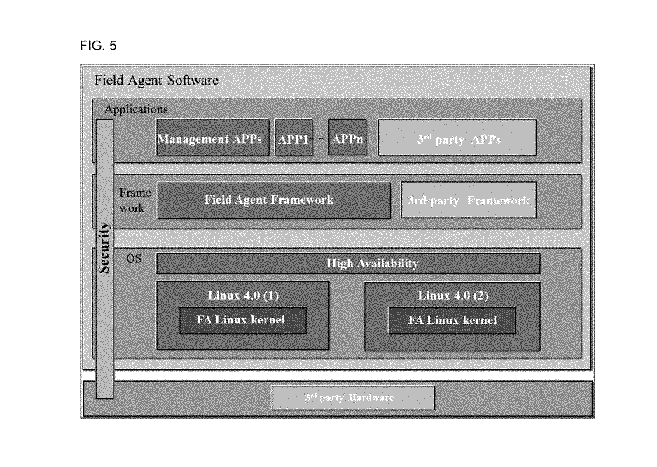

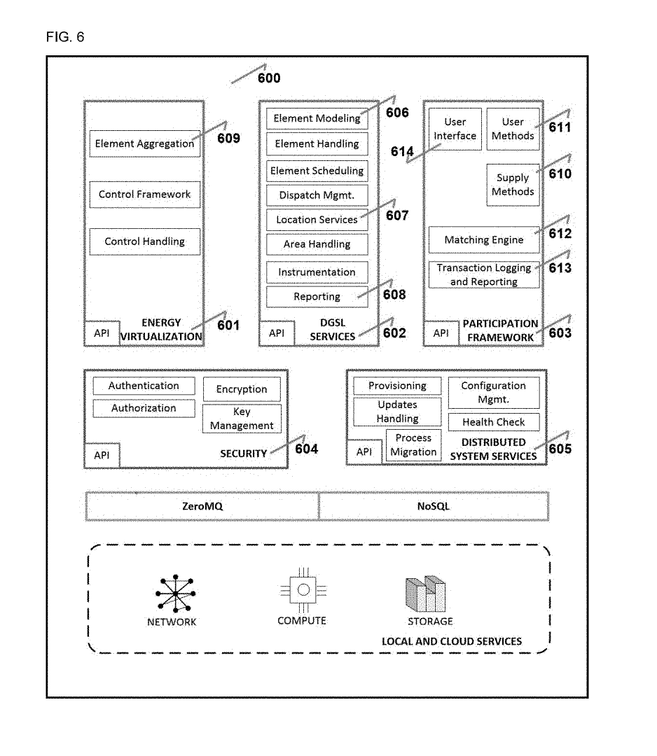

We have chosen to use a Linux build optimized for field deployment, very high availability, and long term unattended operations (see FIG. 5).

### Coordination and Control (Application Stack)

The invention embodiment results from methods, algorithm and computing/communications equipment (autonomous agent) capable of autonomously analyze an energy dispatch (power, phase shift, frequency adjustment) for a given area, map it to the individual loads, generators and storage elements, report the level of obtainment expected, dispatch the individual elements, measure over the time window allocated and report actual obtainment. The invention implements the actual dispatch by a highly distributed process, application of mathematical algorithms to control the immediately connected elements (loads, inverters, etc.), autonomous decision making and real time coordination between all the elements that constitute the aggregation area. Areas aggregate upward into larger areas in order to address ultrahigh scalability.

These elements of the stack constitute the core of the invention. Our Autonomous Agent software architecture is modular and extensible. In order to secure reuse and extensibility each module exports clear and well defined APIs and consumes services from other modules as needed.

The fundamental components of the application stack are:

Application Security Services 604: Authentication; Authorization; Encryption; and Key Management.

Distributed Generation, Storage and Loads Coordination Services: Element modeling, scheduling and handling 602; Dispatch management; Location awareness services; Area Handling (control selection process); Instrumentation; Reporting.

Energy Element Virtualization 601: Elements aggregation; Control framework; Control Handling.

Participation framework 603: User interface; User methods; Supply methods; Matching engine; Transaction logging and reporting.

Distributed System Services 605: Provisioning, Configuration and Updating Management; Health Check; Process Migration.

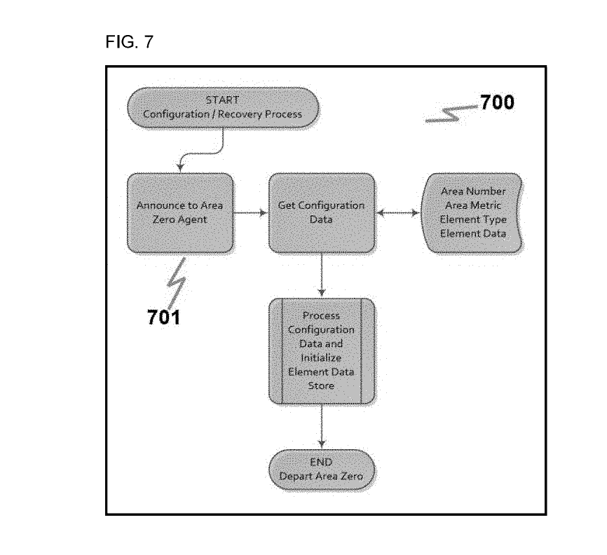

These are represented on the FIG. 6 block diagram and will be discussed in further details in the following subsections.

### Distributed Generation, Storage and Loads Coordination Services

This embodiment of the invention has at its core an Energy Component Model 606. The models are extensible and include between others photovoltaic (PV) system, wind mills, fuel cells, battery banks, inverters, interruptible loads. The Energy Model 606 is distributed across all agents 101 in the area and is used to apply the agoric like control algorithms to support local decisions to achieve area and global effective outcomes.

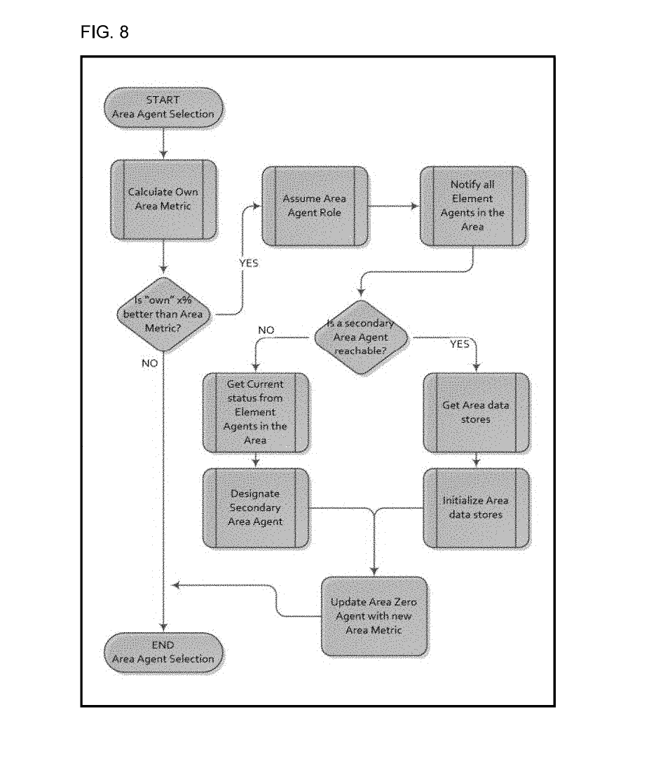

The cloud applications instantiate a specific object at provisioning time for each Element Agent 101. The overall provisioning process is not static but rather a dynamic cycle that repeats as needed (FIG. 7). Such cycle enables agents 101 to get their initial configuration, pick up software updates, recover from corrupted configurations/storage, and recover from fault states. Note that all agents have a physical and a cloud instance, except Area Zero 701 that is instantiated only on the cloud. Area Zero 701 is the homing element for agents' initial discovery as well as fault recovery through their life cycle.

The Element Agent 101 then accepts dispatches, controls the attached element to achieve the accepted dispatch, and schedules capacity and available actions. It uses the instrumentation modules to measure real time obtainment, and aggregates them into periodic reports sent to the Area Agent 102.

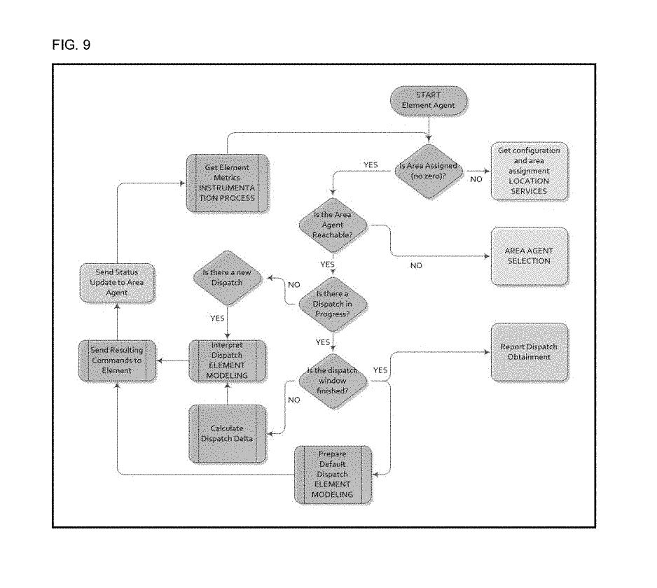

All agents 101 use the location services 607 module to understand their belonging to a specific area and participate of the selection of the Area Agent 102 (FIG. 8). Each area has only one Area Agent 102.

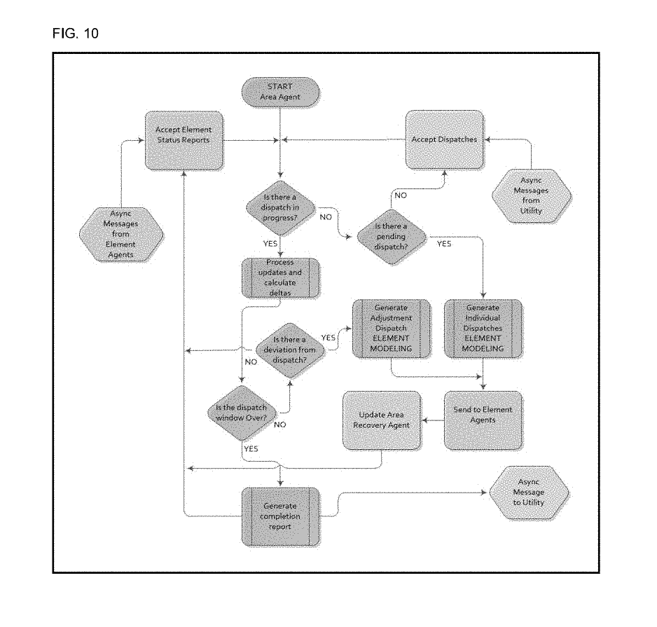

Once the selection process is completed, a single agent assumes the Area Agent 102 personality while all others continue to operate as Element Agent 101 (FIG. 9).

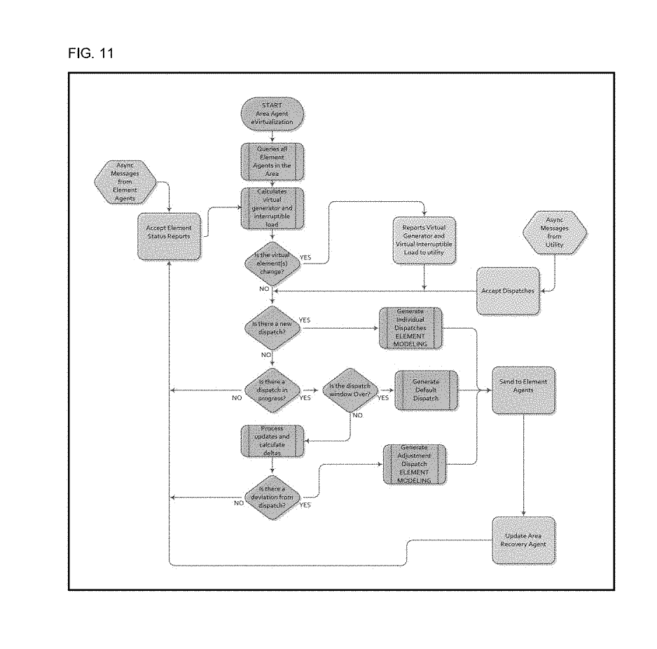

The Area Agent 102, besides its normal operation as an Element Agent 101, has a full area control and coordination responsibility (FIG. 10). It aggregates Element Agents 101 reported capacity and capabilities, reports on the aggregated values and accepts area dispatches. After receiving area dispatches, it breaks them into individual components and communicates individual dispatches to the member Element Agents 101. Lastly it collects obtainment reports from the Element Agents 101, aggregates them and send the area report 608 to the controlling utility 104 and operation/management center 103.

### Energy Element Virtualization 601

Apparatus and related software that aggregates 609 small under management loads, generators and storage elements. A large, utility scale, virtualized load and virtualized generator is presented to the operator 104 representing all the loads, generators and storage under management on a given area. The virtualized elements mimic the characteristics and behaviors of similar size actual generators and loads permitting the grid operator/utility 104 to monitor and manage them as they would with any of their similar utility scale components. In addition it potentially enables individuals to participate of the energy market through the resulting virtual utility scale generator.

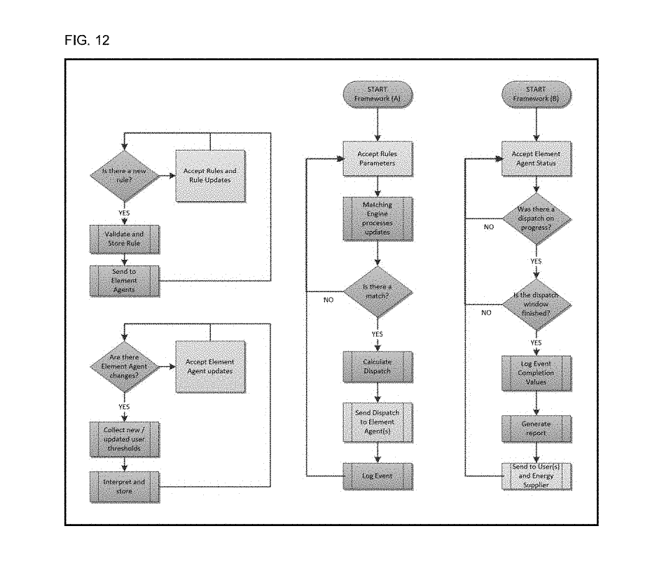

This embodiment of the invention consumes the Energy Component Models 606 through the offered APIs and extend them in order to present virtualized aggregation elements (FIG. 11 depicts the overall process flow). All generator type elements such as PV systems, inverters, battery packs, etc. are aggregated 609 into a virtual generator formed out of the aggregated capabilities. Equivalent aggregation process takes place with loads.

The applications instantiate a specific object at provisioning time for each Element Agent 101. Element Agents 101 have a simpler control framework that allows them to accept and execute dispatches for the specific attached element 201. The dispatch is accepted from the Area Agent 102 and obtainment reports are sent back to such Area Agent 102 in a periodic bases for the duration of the dispatch. When the dispatch expires and until a new dispatch is received, the attached element 201 is allowed to revert to its default behavior.

The Area Agent 102 has a more complex role. It aggregates 609 the capabilities reported by every Element Agent 101 in the area and calculates an equivalent virtualized generator and interruptible load as well as its current capabilities. It periodically reports to the utility 104 the status and capabilities of the virtual generator and interruptible load, and accepts dispatches against it. Periodic obtainment reports are generated and sent to the controlling utility.

### Participation Framework 603

Participation in energy optimization activities requires several participants—end consumer, utilities, energy brokers, etc.—to exchange information—supply, demand, pricing, etc.—with the objective of reaching agreement toward the achievement of a desired outcome (price, quantity, direction of flow, etc.). The invention, based on methods, distributed computing platforms and associated software/APIs, provides a framework as to instantiate the rules 610 and track the agreements required to achieve the desired energy transaction. Furthermore the invention offers transaction logs 613 of agreements and actual execution that can be access by all participants of a given transaction; in addition it provides end users access methods 614 to define their wishes and requirements 611 (rules), and automate (if desired or required) their participation on the energy transaction.

This embodiment of the invention offers APIs and containers as to allow energy supplier and utilities 104 to publish rules 610 that enable the end users' participation of energy efficiency and energy conservation programs (FIG. 12 depicts the overall process flow). The rules could be a variety of economic incentives, penalties, rewards and other regulatory constraints and incentives used by utilities and PUCs to allow market formation and operations, increase transparency, and/or move the market in desired directions to optimize the long term outcomes and preserve the distribution grid long term viability, stability and reliability.

The application provides a clean user interface 614, translates the uploaded rules into easy to understand terms, and provides the constructs as to the end user to express their desirable 611 actions and thresholds.

Finally the matching engine 612 utilizes the user choices, monitors in real time the objects instantiated by the energy suppliers and takes appropriate actions when the offers match the stated thresholds. This level of automation is critical for the effective market operation and transparency. A transaction log 613 is generated and obtainment reports are presented to the user and the energy supplier for transaction clearing.

### CONCLUSIONS

The disclosed embodiments are illustrative, not restrictive. There have been disclosed typical preferred embodiments of the invention in general terms. It is understood that the present invention can be applied to a wide variety of electrical grid topologies, distributed elements and various combinations of the core concepts and services. It is clear that there are many alternative ways of implementing the invention.

From the above discussions we conclude that the following claims fairly represent the unique contributions of our invention to the energy distribution operating efficiency, and electricity market transparency.

1. A distributed energy management system comprising:
at least one electric element;
a plurality of nodes having autonomous agent software which is deployed and executed in such nodes;
cloud computing servers to run at least the cloud instance of each agent and the area zero routing elements;
a communications module for communicating with said plurality of nodes and with said cloud computing servers; and
coordination and control modules for modelling said electric element under management of said energy management system and which coordination and control modules receive and analyze dispatches, organize areas of control, and coordinate with the other nodes in the same area of control in order to achieve optimal electrical energy distribution outcomes.

2. A method for managing an energy system on a distributed basis using a plurality of autonomous agents, comprising the steps of:
self configuring by determining an area of control that such autonomous agents cover and joining other agents in the same area of control to coordinate and control a pool of electric endpoints;
routing after a fault or initial power up, whereby each autonomous agent locates its respective peer agents, recovers software and configuration data related to that autonomous agent, and restores data to a last state;
selecting a coordination hierarchy for such autonomous agent's assigned area of the energy system;
analyzing an energy dispatch including power, phase shift, frequency adjustment; and
mapping the dispatch to individual loads, generators and storage elements under control of said autonomous agent.

3. The distributed energy management system of claim 1 wherein each node further processes inputs to the energy system from external participants to coordinate and achieve desired electric distribution optimization.

4. The distributed energy management system of claim 1, further comprising an energy component modeling module capable of modeling common electric grid endpoints.

5. A method for virtualizing distributed electric generators and storage, said method comprising the steps of:
aggregating smaller under management loads, generators and storage elements;
presenting a large utility scale virtualized load and virtualized generator; and
copying the characteristics and behaviors of similar size physical generators in order to present the virtualized to an operator.

6. The virtualized generator method claim 5, further comprising the step of presenting to an operator information regarding the virtualized generator that would enable the operator to monitor and managed the virtual generator that would be equivalent to a physical generator.

7. A method for facilitating electricity market participation, the method comprising the steps of:
presenting API's and containers for an operator to publish market rules;
offering an end-user with a UI to view rules, state desired actions and thresholds;
monitoring in real time the objects instantiated by energy suppliers;
taking the actions determined by the matching engine based on such entries; and
automating such actions on behalf of the end user.
